(19) United States
(12) Patent Application Publication
(10) Pub. No.: US 2012/0086153 A1
(43) Pub. Date: Apr. 12, 2012

(54) MANUFACTURING METHODS OF CERAMIC FIRED BODY, HONEYCOMB STRUCTURE, AND EXHAUST GAS CONVERTING DEVICE, AND DRYING APPARATUS

(75) Inventors: Ryoichi KUDO, Ibi-Gun (JP); Tsubasa Sonoo, Ibi-Gun (JP); Tadafumi Ohashi, Ibi-Gun (JP); Yuji Haga, Ibi-Gun (JP)

(73) Assignee: IBIDEN CO., LTD., Ogaki-Shi (JP)

(21) Appl. No.: 13/242,931

(22) Filed: Sep. 23, 2011

(30) Foreign Application Priority Data
Oct. 6, 2010 (JP) PCT/JP2010/067595

(51) Int. Cl. H05B 6/64; F26B 3/347

(52) U.S. Cl. 264/432; 34/259

(57) ABSTRACT

A manufacturing method of a ceramic fired body includes forming a composition of ceramic raw material containing water to make a ceramic molded body. The ceramic molded body is irradiated with a microwave under a depressurized atmosphere of about 1 KPa or more and about 50 kPa or less to dry the ceramic molded body. The ceramic molded body is fired to make the ceramic fired body.

### CROSS-REFERENCE TO RELATED APPLICATIONS

The present application claims priority under 35 U.S.C. §119 to International Application No. PCT/JP2010/067595, filed in Japan on Oct. 6, 2010, the entire contents of which are incorporated herein by reference.

### BACKGROUND OF THE INVENTION

1. Field of the Invention

The present invention relates to a manufacturing method of a ceramic fired body, a manufacturing method of a honeycomb structure, a manufacturing method of an exhaust gas converting device, and a drying apparatus.

2. Discussion of the Background

An example exhaust gas conversion system uses ammonia and reduces NOx to nitrogen such as a Selective Catalytic Reduction (SCR) system.

In the SCR system, a catalytic agent for absorbing ammonia and reducing the NOx to nitrogen may be zeolite.

International Publication Pamphlet No. WO 09/141,897A1 discloses a honeycomb structure including a honeycomb unit. The honeycomb unit contains zeolite and inorganic binder, and is formed by aligning plural through holes (cells) in longitudinal directions interposing separating walls. In manufacturing the honeycomb structure, after manufacturing a honeycomb molded body with extrusion molding of a raw material paste containing zeolite, inorganic binder and water, a microwave drying apparatus is used to dry the honeycomb molded body.

The entire contents of International Publication Pamphlet No. WO 09/141,897A1 are incorporated herein by reference.

### SUMMARY OF THE INVENTION

According to one aspect of the present invention, a manufacturing method of a ceramic fired body includes forming a composition of ceramic raw material containing water to make a ceramic molded body. The ceramic molded body is irradiated with a microwave under a depressurized atmosphere of about 1 KPa or more and about 50 kPa or less to dry the ceramic molded body. The ceramic molded body is fired to make the ceramic fired body.

According to another aspect of the present invention, a manufacturing method of a honeycomb structure including a ceramic fired body includes a manufacturing method of the ceramic fired body. The manufacturing method of the ceramic fired body includes forming a composition of ceramic raw material containing water to make a ceramic molded body. The ceramic molded body is irradiated with a microwave under a depressurized atmosphere of about 1 KPa or more and about 50 kPa or less to dry the ceramic molded body. The ceramic molded body is fired to make the ceramic fired body. The ceramic molded body has plural through holes arranged in parallel in longitudinal directions of the plural through holes. Each of the plural through holes is separated from each other by a separating wall.

According to further aspect of the present invention, a manufacturing method of an exhaust gas converting device including a honeycomb structure includes a manufacturing method of the honeycomb structure including a ceramic fired body. The manufacturing method of the honeycomb structure includes a manufacturing method of the ceramic fired body. The manufacturing method of the ceramic fired body includes forming a composition of ceramic raw material containing water to make a ceramic molded body. The ceramic molded body is irradiated with a microwave under a depressurized atmosphere of about 1 KPa or more and about 50 kPa or less to dry the ceramic molded body. The ceramic molded body is fired to make the ceramic fired body. The ceramic molded body has plural through holes arranged in parallel in longitudinal directions of the plural through holes. Each of the plural through holes is separated from each other by a separating wall.

According to further aspect of the present invention, a drying apparatus that dries a ceramic molded body having plural through holes arranged in parallel in longitudinal directions of the through holes, and having a first end surface and a second end surface at each end of the ceramic molded body in a longitudinal direction of the ceramic molded body, each of the through holes being separated from each other by a separating wall, includes a drying room, a depressurizor, a microwave irradiator, and an infrared ray irradiator. The drying room is configured to dry the ceramic molded body. The depressurizor is configured to depressurize an inside of the drying room. The microwave irradiator is configured to irradiate the ceramic molded body inside the drying room with a microwave. The infrared ray irradiator is configured to irradiate both end surfaces of the ceramic molded body in its longitudinal direction with infrared rays.

### BRIEF DESCRIPTION OF DRAWINGS

Amore complete appreciation of the invention and many of the attendant advantages thereof will be readily obtained as the same becomes better understood by reference to the following detailed description when considered in connection with the accompanying drawings.

FIG. 1 is a perspective view of examples honeycomb structure manufactured in embodiments of the present invention.

FIG. 2 is a side view of an example drying apparatus of the embodiments of the present invention.

FIG. 3 is a plan view of the example drying apparatus of the embodiments of the present invention.

FIG. 4 is a cross-sectional view of an example exhaust gas converting device manufactured in the embodiments of the present invention.

FIG. 5 is a perspective view of another example honeycomb structure manufactured in the embodiments of the present invention.

FIG. 6 is a perspective view of a honeycomb unit forming the honeycomb structure of FIG. 5.

### DESCRIPTION OF THE EMBODIMENTS

Embodiments of the present invention may provide a manufacturing method of a ceramic fired body, a manufacturing method of a honeycomb structure, a manufacturing method of an exhaust gas converting device, and a drying apparatus.

The embodiments will now be described with reference to the accompanying drawings, wherein like reference numerals designate corresponding or identical elements throughout the various drawings.

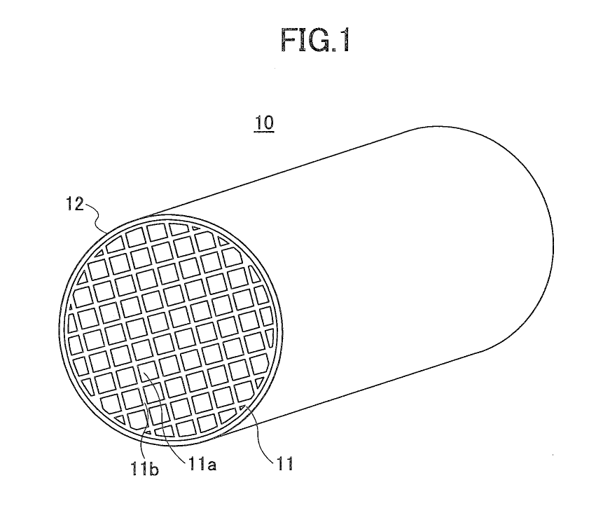

An example manufacturing method of a honeycomb structure 10 of the embodiment of the present invention illustrated in FIG. 1 is described. First, a raw material paste containing water, zeolite and inorganic binder are used, and the raw material paste undergoes extrusion molding to form ceramic molded body in a substantially cylindrical shape in which plural through holes are arranged in parallel in their longitudinal directions while being separated by separating walls.

The ceramic molded body is fired to make a ceramic fired body (a honeycomb unit). When necessary, an outer peripheral coating layer is formed. Thus, the honeycomb structure 10 in the substantially cylindrical shape including the single honeycomb unit is formed.

Zeolite contained in the raw material paste is not specifically limited and may be one or combinations of two or more of β-type zeolite, Y-type zeolite, ferrierite, ZSM-5 zeolite, mordenite, faujasite, zeolite A, zeolite L and phosphate zeolite. Phosphate zeolite is preferable because of its NOx conversion capability.

Phosphate zeolite may be SAPO such as SAPO-5, SAPO-11 and SAPO-34, MeAPO, MeAPSO, and the like.

It is preferable in zeolite that ions are exchanged by at least one of a copper ion and an iron ion in consideration of the NOx conversion capability.

The Zeolite that has undergone the ion exchange with at least one of the copper ion and the iron ion preferably has the amount of ion exchange of about 1.0 to about 5.0 mass %. If the amount of ion exchange of zeolite is about 1.0 mass % or more, the NOx conversion capability is less apt to be insufficient. On the other hand, if the amount of ion exchange of zeolite is about 5.0 mass % or less, a framework geometry of zeolite is less apt to be broken by an influence of water and heat from a site where the ion is exchanged and a metallic ion that has undergone the ion exchange is less apt to be a metallic oxide and the NOx conversion capability is less apt to be insufficient.

Zeolite may undergo the ion exchange with a metallic ion other than those described above.

Average particle diameters of a primary particle and a secondary particle of zeolite are preferably about 0.5 to about 10 μm, more preferably about 1 to about 5 μm. If the average particle diameter of the primary particle or the secondary particle of zeolite is about 0.5 μm or more, a porosity of the honeycomb unit 11 is less apt to be reduced by a filling effect of zeolite. As a result, an exhaust gas may easily penetrate into an inside of the separating wall. Thus, zeolite is apt to be effectively used for conversion of NOx. On the other hand, if the average particle diameter of the primary particle or the secondary particle of zeolite is about 10 μm or more, a surface area of the honeycomb unit 11 is less apt to be small and therefore an area of zeolite contacting the exhaust gas becomes large. As a result, the NOx conversion capability is less apt to be insufficient.

The content of zeolite per an apparent volume in the honeycomb unit 11 is preferably about 230 to about 360 g/L. If the content of zeolite per the apparent volume in the honeycomb unit 11 is about 230 g/L or more, the NOx conversion capability is less apt to be insufficient. On the other hand, if the content of zeolite per the apparent volume in the honeycomb unit 11 is about 360 g/L or less, the content of the inorganic binder in the honeycomb unit 11 is less apt to be reduced. Then, the strength of the honeycomb unit 11 is less apt to be insufficient or an aperture ratio of the honeycomb unit 11 is less apt to be small to thereby obstruct an increment of a pressure loss.

The inorganic binder is not specifically limited and may be one or combinations of two or more solid contents of alumina sol, silica sol, titania sol, water glass, sepiolite, attapulgite, boehmite, and the like.

The content of the inorganic binder in the honeycomb unit 11 is preferably about 5 to about 30 mass %, more preferably about 10 to about 20 mass %. If the content of the inorganic binder in the honeycomb unit 11 is about 5 mass % or more, the strength of the honeycomb unit 11 is less apt to be small. On the other hand, if the content of the inorganic binder in the honeycomb unit 11 is about 30 mass % or less, the content of zeolite in the honeycomb unit 11 is less apt to be small to thereby obstruct insufficiency of the NOx conversion capability.

The raw material paste may preferably to contain one or more selected from a group including an inorganic fiber, a flake-like material, a tetrapod-like material and a three-dimensional needle-like material (e.g., a three-dimensional acicular material) in order to make the strength of the honeycomb unit 11 great.

The inorganic fiber contained in the raw material paste is not specifically limited as long as the strength of the honeycomb unit 11 is improved, and may be one or combinations of two or more of alumina, silica, silicon carbide, silica alumina, glass, potassium titanate, aluminum borate, and the like.

An aspect ratio of the inorganic fiber is preferably about 2 to about 1000, more preferably about 10 to about 500. If the aspect ratio of the inorganic fiber is about 2 or more, an effect of improving the strength of the honeycomb unit 11 is less apt to be lowered. On the other hand, if the aspect ratio of the inorganic fiber is about 1000 or less, a die may be less apt to be clogged by the inorganic fiber in the extrusion molding of the honeycomb unit 11 or the inorganic fiber may be less apt to be broken to obstruct reduction of an effect of improving the strength of the honeycomb unit 11.

The flake-like material may be in a flat shape, and preferably has a thickness of about 0.2 to about 5 μm, a maximum length of about 10 to about 160 μm, and a ratio of the maximum length to the thickness of about 3 to about 250.

The flake-like material contained in the raw material paste is not specifically limited as long as the strength of the honeycomb unit 11 is improved, and may be one or combinations of two or more of glass, white mica, alumina, silica and the like.

The tetrapod-like material may have needle-like portions extending in three-dimensional directions. The average length of the needle-like portions are preferably about 5 to about 30 μm and the average diameter is preferably about 0.5 to about 5 μm.

The tetrapod-like material may be monocrystal, whisker, and the like.

The material of the tetrapod-like material contained in the raw material paste is not specifically limited and may be one or combinations of two or more of zinc oxide or the like.

The three-dimensional needle-like material is formed by connecting the needle-like portions by an inorganic material such as glass at around centers of the needle-like portions, and preferably has the average needle length of about 5 to about 30 μm and the average diameter of about 0.5 to about 5 μm.

The three-dimensional needle-like material may be formed by arranging plural needle-like portions in the three-dimensional directions. The diameter of the needle-like portion is preferably about 0.1 to about 5 μm, the length of the needle-like portion is preferably about 0.3 to about 30 μm, and a ratio of the length relative to the diameter is preferably about 1.4 to about 50.

The three-dimensional needle-like material contained in the raw material paste is not specifically limited, and may be one or combinations of two or more alumina, silica, silicon carbide, silica alumina, glass, potassium titanate, aluminum borate, boehmite, zinc oxide, and the like.

The content of one or more materials in the honeycomb unit 11 selected from a group including the inorganic fiber, the flake-like material, the tetrapod-like material and the three-dimensional needle-like material is preferably about 3 to about 50 mass %, more preferable about 3 to about 30 mass %, further more preferably about 5 to about 20 mass %. If the content of one or more materials in the honeycomb unit 11 selected from a group including the inorganic fiber, the flake-like material, the tetrapod-like material and the three-dimensional needle-like material is about 3 mass % or more, an effect of improving the strength of the honeycomb unit 11 is less apt to be reduced. Meanwhile, if the content of one or more materials in the honeycomb unit 11 selected from a group including the inorganic fiber, the flake-like material, the tetrapod-like material and the three-dimensional needle-like material is about 50 mass % or more, the content of the zeolite in the honeycomb unit 11 is less apt to be reduced and the NOx conversion capability is less apt to be degraded.

An organic binder, a dispersing medium, a molding auxiliary agent or the like may be appropriately added to the raw material paste when necessary.

The organic binder is not specifically limited, and may be one or combinations of two of methyl cellulose, carboxymethyl cellulose, hydroxyethyl cellulose, polyethylene glycol, phenol resin, epoxy resin, and the like. The additive amount of the organic binder is preferably about 1 to about 10% relative to the total mass of the zeolite, the inorganic binder, the inorganic fiber, the flake-like material, the tetrapod-like material and the three-dimensional needle-like material.

The dispersing medium is not specifically limited, and may be one or combinations of two or more of water, an organic solvent such as benzene, alcohol such as methanol or the like.

The molding auxiliary agent is not specifically limited, and may be one or combinations of two or more of ethylene glycol, dextrin, fatty acid, fatty acid soap, polyalcohol, and the like.

In preparing the raw material paste, it is preferable to mix and knead. A mixer, an attritor or the like can be used for mixing and a kneader or the like may be used for kneading.

Next, the drying apparatus of the embodiments of the present invention is used to dry the obtained ceramic molded body.

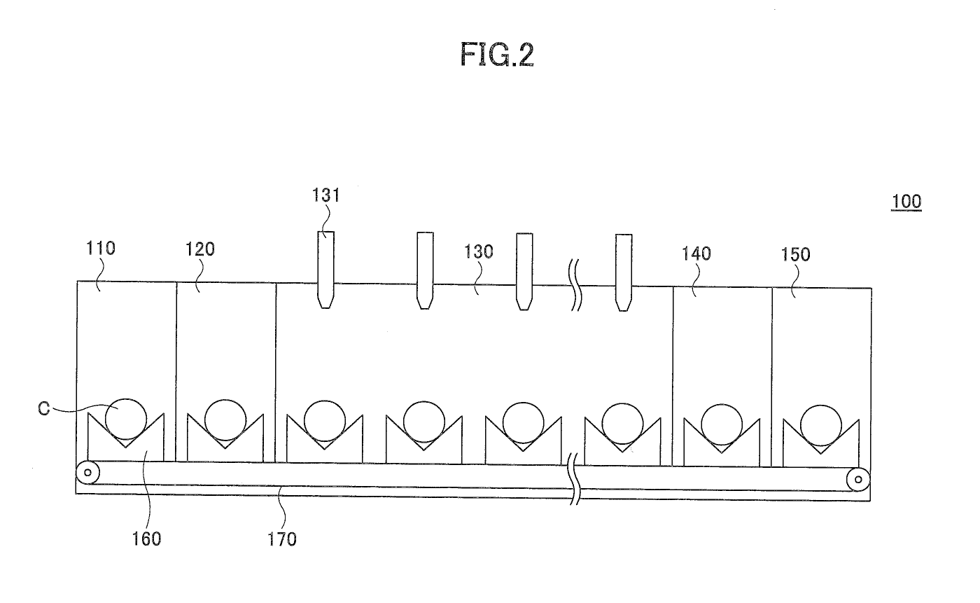

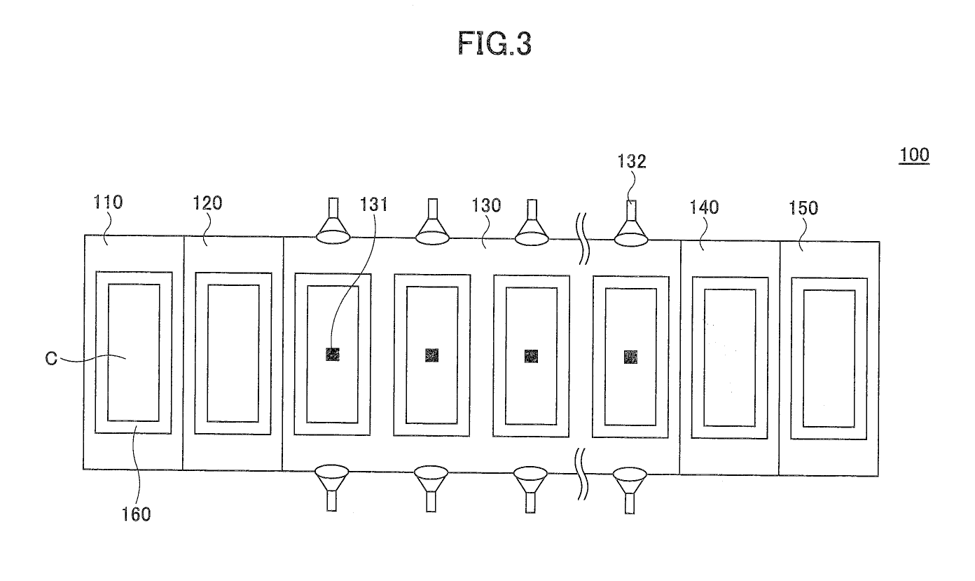

FIG. 2 and FIG. 3 illustrate an example drying apparatus of the embodiments of the present invention. The drying apparatus 100 is a continuous type and includes a buffer room 110, a depressurizing room 120, a drying room 130, a repressurizing room 140, and a buffer room 150. The buffer room 110, the depressurizing room 120, the drying room 130, the repressurizing room 140, and the buffer room 150 are sequentially arranged in a direction of carrying the ceramic molded body C. The ceramic molded body C is fixed to a jig 160 and carried by the conveyer (e.g. a conveyer) 170. At this time, the depressurizing room 120, the drying room 130 and the repressurizing room 140 can be depressurized by a decompression device (not illustrated). A microwave radiating device 131 is installed on an upper portion of the drying room 130 to irradiate the ceramic molded body C with microwaves. Infrared ray irradiators 132 for irradiating side surfaces of the ceramic molded body C in its longitudinal direction are installed in double side surfaces of the ceramic molded body C.

Doors may be provided between the buffer room 110 and the depressurizing room 120, between the depressurizing room 120 and the drying room 130, between the drying room 130 and the repressurizing room 140, and between the repressurizing room 140 and the buffer room 150 to maintain the depressurized pressure of the depressurizing room 120 and the drying room 130. The doors can open or close when the ceramic molded body C passes.

The decompression device is not specifically limited and may be a vacuum pump.

The microwave radiating device 131 is not specifically limited as long as microwaves can irradiate with the microwave radiating device 131.

The infrared ray irradiator 132 is not specifically limited, and may be a lamp heater, a halogen heater, a far infrared rays (FIR) heater, a LT heater, a colce heater, a carbon heater, a colche heater, a quartz heater, and the like. The infrared ray irradiator 132 may preferably be the lamp heater, the halogen heater, or the FIR heater.

Next, a method of drying the ceramic molded body C with the drying apparatus 100 is described. In the buffer room 110, the ceramic molded body C is fixed to the jig 160 so that the longitudinal direction of the ceramic molded body C is positioned substantially perpendicular to the carrying direction of the conveyer 170 on a horizontal surface of the conveyer 170. Then, the ceramic molded body C is carried by the conveyer 170 to the drying room 130 depressurized by the decompression device (not illustrated) via the depressurizing room 120 depressurized by the decompression device (not illustrated).

At this time, the pressure of the drying room is about 1 to about 50 kPa, preferably about 2 to about 50 kPa, more preferably about 2 to about 20 kPa, still more preferably about 3 to about 10 kPa. If the pressure of the drying room is about 1 KPa or more, electric discharge is less apt to occur. On the other hand, if the pressure of the drying room is about 50 kPa or less, a temperature difference between the inside of the ceramic molded body C and the outer peripheral portion is less apt to be large and cracks in the ceramic molded body is less apt to occur.

Although the drying room is not ordinarily heated, the drying room may be heated when necessary.

An atmosphere of the drying room 130 is ordinarily an air. However, the air may be replaced by an inert gas such as nitrogen.

Next, when the ceramic molded body C is delivered to a drying position inside the drying room 130, the ceramic molded body C is prevented from being delivered by a predetermined time duration. During the prevention of the delivery, the microwave radiating device 131 irradiates the ceramic molded body with a microwave and an infrared ray irradiator 132 irradiates both end surfaces of the ceramic molded body C in its longitudinal direction with infrared rays.

When the ceramic molded body C is irradiated by the microwaves, the temperature of the ceramic molded body C increases and water contained in the ceramic molded body evaporates. At this time, because heat in the outer peripheral portion of the honeycomb molded body C is dissipated, a temperature difference occurs between the inside and the outer peripheral portion of the ceramic molded body C. However, since the pressure inside the drying room is about 1 to about 50 kPa, the temperature at which water evaporates is apt to decrease and a temperature difference between the inside and the outer peripheral portion of the honeycomb molded body is apt to be small. As a result, it is possible to easily prevent cracks from occurring in the ceramic molded body C.

The outer peripheral portion of the ceramic molded body C includes the both end surfaces of the ceramic molded body C in its longitudinal direction.

On the other hand, in the both end surfaces of the ceramic molded body in its longitudinal direction, heat quantity dissipated from a center portion of the ceramic molded body in its longitudinal direction is large. When the both end surfaces of the ceramic molded body in its longitudinal direction are irradiated by infrared rays, the both end surfaces of the ceramic molded body in its longitudinal direction is apt to increase and a temperature difference between the central portion and the both end portions of the ceramic molded body in its longitudinal direction is apt to be made further small.

The doses of the microwaves and the infrared rays are appropriately adjustable in association with the material forming the ceramic molded body C, the size of the ceramic molded body C, the pressure of the drying room 130 or the like.

The delivery of the ceramic molded body C with the conveyer 170 is stopped for predetermined time durations at plural drying positions, and the ceramic molded body C can be dried.

Further, if the temperature difference between the inside and the outer peripheral portion of the ceramic molded body C can be reduced without irradiating the both end surfaces of the ceramic molded body C in its longitudinal direction with infrared rays, the infrared rays may not be irradiated.

The ceramic molded body C dried as described above is delivered by the conveyer 170 to the buffer room 170 via the repressurizing room 140 which is depressurized by the decompression device (not illustrated). Thereafter, the dried ceramic molded body is recovered.

Further, the recovered ceramic molded body C is degreased. A condition for degreasing the ceramic molded body is not specifically limited and is appropriately selectable depending on the kind and the amount of the organic substance. The condition is preferably about two hours at a temperature of about 400° C.

By firing the degreased ceramic molded body, the honeycomb unit 11 in a substantially cylindrical shape is acquired. The firing temperature is preferably about 600 to about 1200° C., more preferably about 600 to about 1000° C. If the firing temperature is about 600° C. or more, a condensing reaction with the inorganic binder is apt to proceed and the strength of the honeycomb unit 11 is less apt to be lowered. On the other hand, if the firing temperature is about 1200° C. or less, calcination of zeolite is less apt to be too rapid thereby obstructing a reduction of reaction sites of zeolite.

Next, a paste for the outer peripheral coating layer is coated on the outer peripheral surfaces of the honeycomb units 11 in a substantially cylindrical shape except for the both ends of the honeycomb units 11.

The paste for the outer peripheral coating layer is not specifically limited and may be a mixture of an inorganic binder and an inorganic particle, a mixture of an inorganic binder and an inorganic fiber, and a mixture of an inorganic binder, an inorganic particle, an inorganic fiber, and the like.

The paste for the outer peripheral coating layer may further contain the organic binder.

The organic binder is not specifically limited and may be one or combinations of two or more of polyvinyl alcohol, methyl cellulose, ethyl cellulose, carboxymethyl cellulose, and the like.

Next, the honeycomb unit on which the paste for the outer peripheral coating layer is coated is dried and solidified to thereby acquire the honeycomb structure 10 in the substantially cylindrical shape. If the organic binder is contained in the paste for the outer peripheral coating layer, it is preferable to degrease the honeycomb unit before coating. The degreasing condition can be appropriately selected depending on the kind and/or the quantity of the organic substance and may be a temperature of about 700° C. for a time of about 20 minutes.

It is possible to exchange ions of zeolite by immersing the honeycomb unit 11 in an aqueous solution containing at least one of copper ions and iron ions. A raw material paste containing zeolite of which ions are exchanged by at least one of copper ions and iron ions may be used to manufacture the honeycomb unit.

The honeycomb structure 10 includes a honeycomb unit 11, which is formed by the through holes 11a and the separating walls 11b for separating the through holes 11a and arranged in the longitudinal direction of the honeycomb unit 11, and an outer peripheral coating layer 12 formed on the outer peripheral surface of the honeycomb unit 11.

The honeycomb unit 11 preferably has a porosity of about 25 to about 40%. This is because if the porosity of the honeycomb unit 11 is about 25% or more, an exhaust gas easily penetrates inside the separating wall 11b and zeolite is apt to be effectively used for conversion for NOx. On the other hand, if the porosity of the honeycomb unit 11 is about 40% or less, the strength of the honeycomb unit 11 is less apt to be insufficient.

It is preferable that the aperture (open area) ratio of the honeycomb unit 11 on a cross-sectional surface perpendicular to the longitudinal direction of the honeycomb unit 11 is about 50 to about 75%. If the aperture ratio of the honeycomb unit 11 in the cross-sectional surface perpendicular to the longitudinal direction of the honeycomb unit 11 is about 50% or more, zeolite is apt to be effectively used for the conversion of NOx. On the other hand, if the aperture ratio of the honeycomb unit 11 in the cross-sectional surface perpendicular to the longitudinal direction of the honeycomb unit 11 is about 75% or less, the strength of the honeycomb unit 11 is less apt to be insufficient.

The honeycomb unit 11 preferably has the density of the through holes 11a in the cross-sectional surface perpendicular to the longitudinal direction of the honeycomb unit 11 of about 31 to about 140 holes/cm². If the density of the through holes 11a in the cross-sectional surface perpendicular to the longitudinal direction of the honeycomb unit 11 is about 31 holes/cm² or more, zeolite easily contacts the exhaust gas thereby obstructing degradation of the NOx conversion capability. On the other hand, if the density of the through holes 11a in the cross-sectional surface perpendicular to the longitudinal direction of the honeycomb unit 11 is about 140 holes/cm² or less, a pressure loss of the honeycomb structure 10 is less apt to increase.

The thickness of the separating walls 11b of the honeycomb unit 11 is preferably about 0.10 to about 0.50 mm, more preferably about 0.15 to about 0.35 mm. If the thickness of the separating wall 11b is about 0.10 mm or more, the strength of the honeycomb unit 11 is less apt to be degraded. On the other hand, if the thickness of the separating wall 11b is about 0.50 mm or less, the exhaust gas easily penetrates inside the separating wall 11b. As a result, zeolite is apt to be effectively used for the conversion of NOx.

The outer peripheral coating layer 12 preferable has a thickness of about 0.1 to about 2 mm. If the thickness of the outer peripheral coating layer 12 is about 0.1 mm or more, the strength of the honeycomb structure 10 is less apt to be insufficiently improved. Meanwhile, if the thickness of the outer peripheral coating layer 12 is about 2 mm or less, the content of the phosphate zeolite per a unit volume in the honeycomb structure 10 is less apt to decrease thereby obstructing a deterioration in the NOx conversion capability.

The honeycomb structure 10 is a substantially cylindrical shape in FIG. 2. However, the shape is not specifically limited and may be a substantially rectangular pillar shape, a substantially cylindroid shape, and the like. Further, the through hole 11a is a substantially quadrangular pillar shape in FIG. 2. However, the shape is not specifically limited and may be a substantially triangular pillar shape or a substantially hexagonal pillar shape.

The outer peripheral coating layer 12 may not be formed in the honeycomb structure 12.

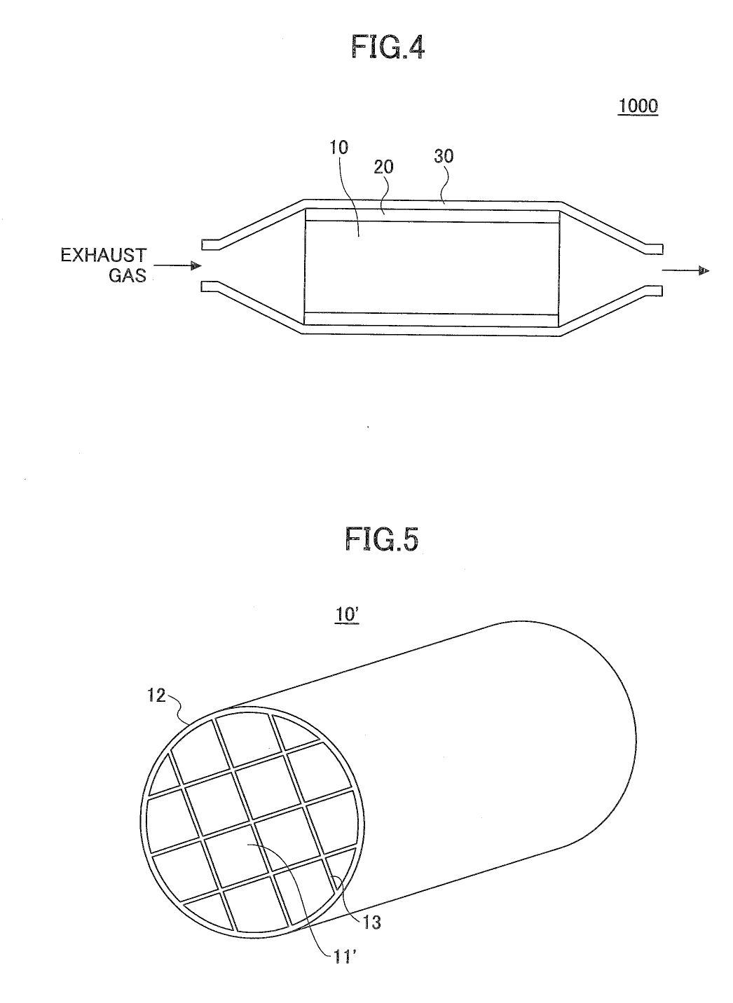

While the holding sealing material 20 is arranged on the outer periphery of the honeycomb structure 10, the honeycomb structure 10 and the holding sealing material 20 are canned into a metallic pipe 30 to thereby acquire the exhaust gas converting device 1000 illustrated in FIG. 4. An injector (not illustrated) such as an injection nozzle for injecting ammonia or a material producing ammonia by decomposing the material is provided in the exhaust gas converting device 1000 on an upper stream side of the honeycomb structure 10 relative to the direction of flowing the exhaust gas. Because ammonia is added to the exhaust gas, NOx contained in the exhaust gas is reduced by zeolite contained in the honeycomb unit 11.

The material producing ammonia by decomposing the material is not specifically limited as long as the material can generate ammonia. In consideration of the storage stability, urea aqueous solution is preferable.

Urea aqueous solution causes hydrolytic cleavage if it is heated by the exhaust gas to thereby generates ammonia.

Another example manufacturing method of the honeycomb structure 10′ of the embodiment of the present invention illustrated in FIG. 5 is described. In a similar manner to the honeycomb unit 11, the honeycomb unit 11′ in a substantially quadrangular pillar shape is manufactured. Then, a paste for an adhesive layer is coated on outer peripheral surfaces other than the both end surfaces of the honeycomb units 11′. Then, the honeycomb units 11′ are sequentially bonded and dried to solidify. Thus, an assembly of the honeycomb units 11′ is formed.

After manufacturing the assembly of the honeycomb unit 11′, the assembly of the honeycomb unit 11′ is cut to be in a substantially cylindrical shape. It is possible to manufacture the assembly of the honeycomb unit 11′ in the substantially cylindrical shape by bonding the honeycomb units 11′ shaped like a substantially sector, a substantially square, and the like in their cross-sections perpendicular to the longitudinal directions of the honeycomb units 11′.

The paste for the adhesive layer is not specifically limited and may be a mixture of an inorganic binder and an inorganic particle, a mixture of an inorganic binder and an inorganic fiber, and a mixture of an inorganic binder, an inorganic particle and an inorganic fiber.

The paste for the adhesive layer may contain an organic binder.

The organic binder is not specifically limited and may be one or combinations of two or more of polyvinyl alcohol, methyl cellulose, ethyl cellulose, carboxymethyl cellulose, and the like.

Next, a paste for the outer peripheral coating layer is coated on the outer peripheral surfaces of the assembly of the honeycomb units 11′ in the substantially cylindrical shape.

The paste for the outer peripheral coating layer is not specifically limited. The paste for the outer peripheral coating layer may contain the same material as the paste for the adhesive layer or a different material. The paste for the outer peripheral coating layer may have substantially the same composition as the paste for the adhesive layer.

Next, the honeycomb unit 11 on which the paste for the outer peripheral coating layer is coated is dried and solidified to thereby acquire the honeycomb structure 10′ in the substantially cylindrical shape. If the organic binder is contained in the paste for the adhesive layer and/or the paste for the outer peripheral coating layer, it is preferable to degrease the honeycomb structure 10′. The degreasing condition can be appropriately selected depending on the kind and/or the quantity of the organic substance and may be a temperature of about 700° C. for a time of about 20 minutes.

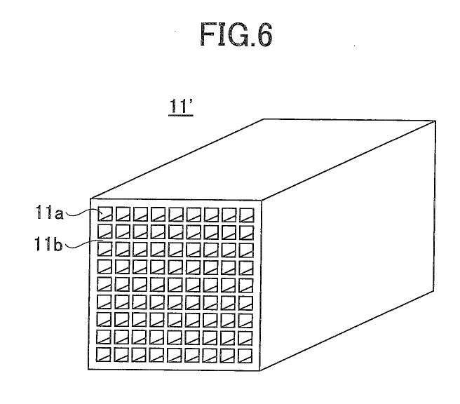

The honeycomb structure 10′ is similar to the honeycomb structure 10 except for the feature that the plural honeycomb units 11′, which are formed by the through holes 11a and the separating walls 11b for separating the through holes 11a and arranged in the longitudinal direction of the honeycomb unit 11 (see FIG. 6), are bonded by interposing the adhesive layer 13.

It is preferable that the cross-sectional area of the honeycomb unit 11′ on a cross-sectional surface perpendicular to the longitudinal direction of the honeycomb unit 11 is about 5 to about 50 cm². If the cross-sectional area of the honeycomb unit 11′ on the cross-sectional surface perpendicular to the longitudinal direction of the honeycomb unit 11 is about 5 cm² or more, the pressure loss of the honeycomb structure 10′ is less apt to increase. On the other hand, if the cross-sectional area of the honeycomb unit 11′ on the cross-sectional surface perpendicular to the longitudinal direction of the honeycomb unit 11 is about 50 cm² or less, the strength against thermal stress generated in the honeycomb unit 11 is less apt to be insufficient.

The properties other than the cross-sectional area of the honeycomb unit 11′ on the cross-sectional surface perpendicular to the longitudinal direction of the honeycomb unit 11 are similar to those in the honeycomb unit 11.

The thickness of the adhesive layer 13 is preferably about 0.5 to about 2 mm. If the thickness of the adhesive layer 13 is about 0.5 mm or more, the adhesion strength of the honeycomb unit 11 is less apt to be insufficient. On the other hand, if the thickness of the adhesive layer is about 2 mm or less, the pressure loss of the honeycomb structure 10′ is less apt to increase.

The honeycomb units 11′ other than the honeycomb units 11′ positioned in the outer peripheral portions of the honeycomb structure 10′ are a substantially quadrangular pillar shape. However, the shape is not specifically limited and may be a substantially hexagonal pillar shape or the like.

The outer peripheral coating layer 12 may not be formed in the honeycomb structure 10′.

The honeycomb units 11 and 11′ as the ceramic fired bodies have been described above. The shapes of the ceramic fired bodies are not specifically limited. The material of the ceramic fired bodies is not specifically limited and may be alumina, silica, titania, zirconia, ceria, mullite, zeolite, cordierite, aluminum titanate, silicon nitride, and the like.

A drying apparatus of the embodiment of the present invention is effective in manufacturing the ceramic fired body (honeycomb unit). Especially, the drying apparatus of the embodiment of the present invention is effective in manufacturing the ceramic fired body (honeycomb unit) containing zeolite.

### EXAMPLES

### Example 1

SAPO-34 whose primary particle is of 3000 parts by mass and has an average particle diameter of 3 μm, boehmite being of 840 parts by mass and having a mean fiber diameter of 6 μm, alumina fiber being of 650 parts by mass and having a mean fiber length of 100 μm, methyl cellulose of 330 parts by mass, oleic acid of 330 parts by mass, and ion-exchange water of 1800 parts by mass are mixed and kneaded to manufacture a raw material paste.

Next, the raw material paste undergoes extrusion molding with an extrusion molding machine to thereby manufacture ceramic molded body having a square pillar shape. Thereafter, the drying apparatus 100 is used to make a pressure of the drying room 130 be 6.7 kPa. While the drying room 130 is not heated and the atmosphere inside the drying room is room air, the ceramic molded body is dried for 15 minutes (0.25 hours). The output of the microwave radiating device 131 is 6 kW. The infrared ray irradiator 132 is an infrared ray heater, and the output of the infrared ray heater is 150 W.

At this time, the temperature difference of the ceramic molded body between the inside and the outer peripheral portion is 2.5° C. and a rate of incidence of the cracks of the ceramic molded body is 0%.

The temperature difference of the ceramic molded body between the inside and the outer peripheral portion is measured by an optical fiber type thermometer manufactured by Neoptix, Inc. at a central portion in the vicinity of the end surfaces of the ceramic molded body and at an edge in the vicinity of the end surface inside the drying room 130.

The rate of incidence of the cracks in the ceramic molded body is acquired by visual judgment of the cracks in the ceramic molded body of 100 pieces delivered into the buffer room 150.

The dried ceramic molded body is degreased at a temperature of 400° C. for 5 hours. Thereafter, the degreased ceramic molded body is fired at a temperature of 700° C. for 2 hours. Thus, the honeycomb unit 11′ having a side of 38 mm and a length of 150 mm in a square pillar shape illustrated in FIG. 6 is manufactured. In the honeycomb unit 11′, a density of the through hole 11a is 62 pieces/cm2 and the thickness of the separating wall is 0.28 mm.

Alumina fiber of 767 parts by mass whose mean fiber diameter is 0.5 μm and mean fiber length of 15 μm, silica glass of 2500 parts by mass, carboxymethyl cellulose of 17 parts by mass, silica sol of 600 parts by mass whose solid content is 30 mass %, polyvinyl alcohol of 167 parts by mass, a surface-active agent of 167 parts by mass, and alumina balloons of 17 parts by mass are mixed and kneaded to manufacture a paste for the heat resistant adhesive layer.

The paste for the adhesive layer is coated so that the thickness of the adhesive layer becomes 2 mm, and the honeycomb units 11′ as many as sixteen (16) are bonded. After the paste of the adhesive layer is dried at a temperature of 150° C. for a time of 10 minutes, a diamond cutter is used to cut the assembly of the honeycomb unit 11 having the square pillar shape so that the honeycomb unit 11′ is a cylindrical shape and cross-sectional surfaces of the honeycomb unit 11′ in perpendicular to the longitudinal direction of the honeycomb unit 11′ is symmetric about a point. Thus, the assembly of the honeycomb unit 11′ having the cylindrical shape is manufactured.

Further, after coating the outer peripheral surface of the assembly of the honeycomb unit 11′ to have the thickness of the outer peripheral coating layer of 1 mm, a microwave drying apparatus or a hot air drying apparatus is used to dry the paste of the adhesive layer at a temperature of 150° C. and a time for 10 minutes to dry and solidify the honeycomb structure 10′. Further, the honeycomb structure 10′ is degreased for 2 minutes. Then, the honeycomb structure 10′ in a cylindrical shape having a diameter of 143.8 mm and a height of 150 mm illustrated in FIG. 5 is manufactured.

While a holding sealing material (a mat made of an inorganic fiber) 20 is arranged on the outer periphery of the honeycomb structure 10′, the honeycomb structure 10′ and the holding sealing material 20 are canned into a metallic pipe (a shell) 30 to thereby acquire an exhaust gas converting device 2 illustrated in FIG. 2.

### Example 2

A honeycomb structure 10′ and an exhaust gas converting device are manufactured in a similar manner to Example 1 except that the ceramic molded body is not irradiated by the infrared rays at a time of drying the ceramic molded body.

At this time, the temperature difference of the ceramic molded body between the inside and the outer peripheral portion is 14.8° C. and a rate of incidence of cracks of the ceramic molded body is 5%.

### Example 3

A honeycomb structure 10′ and an exhaust gas converting device are manufactured in a similar manner to Example 2 except that the pressure inside the drying room 130 is 2.0 kPa.

At this time, the temperature difference of the ceramic molded body between the inside and the outer peripheral portion is 1.2° C. and a rate of incidence of the cracks of the ceramic molded body is 0%.

### Example 4

A honeycomb structure 10′ and an exhaust gas converting device are manufactured in a similar manner to Example 2 except that the pressure inside the drying room 130 is 50.0 kPa.

At this time, the temperature difference of the ceramic molded body between the inside and the outer peripheral portion is 20.4° C. and a rate of incidence of the cracks of the ceramic molded body is 8%.

### Comparative Example 1

A honeycomb structure and an exhaust gas converting device are manufactured in a similar manner to Example 2 except that the pressure inside the drying room 130 is 101.3 kPa.

At this time, the temperature difference of the ceramic molded body between the inside and the outer peripheral portion is 35.0° C. and a rate of incidence of the cracks of the ceramic molded body is 100%.

### Comparative Example 2

A honeycomb structure and an exhaust gas converting device are manufactured in a similar manner to Example 1 except that the pressure inside the drying room 130 is 86.7 kPa, the output of the microwave radiating device 131 is 60 W, the outputs of the infrared ray heaters are 10 W, and the ceramic molded body is dried for 24 hours.

At this time, the temperature difference of the ceramic molded body between the inside and the outer peripheral portion is 10.4° C. and a rate of incidence of the cracks of the ceramic molded body is 0%.

### Comparative Example 3

A honeycomb structure and an exhaust gas converting device are manufactured in a similar manner to Example 2 except that the pressure inside the drying room 130 is 86.7 kPa.

At this time, the temperature difference of the ceramic molded body between the inside and the outer peripheral portion is 32.1° C. and a rate of incidence of the cracks of the ceramic molded body is 100%.

Drying condition and evaluation results of the ceramic molded body are illustrated in Table 1.

TABLE 1

| | | | | CERAMIC MOLDED BODY | |
|---|---|---|---|---|---|
| | | | | TEMPERATURE | |
| | | | | DIFFERENCE | |
| | DRYING CONDITION | | | BETWEEN | |
| | PRESSURE | | | INSIDE AND | INCIDENCE |
| | INSIDE | IRRADIATION | | OUTER | RATE OF |
| | DRYING ROOM | OF | DRYING TIME | PERIPHERAL | CRACK |
| | [kPa] | INFRARED RAY | [hours] | PORTION [° C.] | [%] |
| EXAMPLE 1 | 6.7 | EXIST | 0.25 | 2.5 | 0 |
| EXAMPLE 2 | 6.7 | NOT EXIST | 0.25 | 14.8 | 5 |
| EXAMPLE 3 | 2.0 | NOT EXIST | 0.25 | 1.2 | 0 |
| EXAMPLE 4 | 50.0 | NOT EXIST | 0.25 | 20.4 | 8 |
| COMPARATIVE | 101.3 | NOT EXIST | 0.25 | 35.0 | 100 |
| EXAMPLE 1 | | | | | |
| COMPARATIVE | 86.7 | EXIST | 24 | 10.4 | 0 |
| EXAMPLE 2 | | | | | |
| COMPARATIVE | 86.7 | NOT EXIST | 0.25 | 32.1 | 100 |
| EXAMPLE 3 | | | | | |

Referring to Table 1, when the honeycomb units 11′ of Examples 1 to 4 are manufactured, even if a time for drying the ceramic molded body is 15 minutes (0.25 hours), the temperature difference between the inside and the outer peripheral portion of the ceramic molded body becomes small to thereby prevent the cracks from forming in the ceramic molded body. With Example 1, if the both end surfaces of ceramic molded body in its longitudinal direction is irradiated by infrared rays to dry the ceramic molded body, the temperature difference between the inside and the outer peripheral portion becomes small to thereby further prevent the cracks from forming in the ceramic molded body.

On the other hand, when the honeycomb units of Comparative Examples 1 and 3 are manufactured, if the time for drying the ceramic molded body is 15 minutes (0.25 hours), the pressure inside the drying room 130 is more than 50 kPa. Therefore, it is assumed that the temperature difference between the inside and the outer peripheral portion of the ceramic molded body becomes large to thereby easily form cracks in the ceramic molded body.

When the honeycomb unit of Comparative Example 2 is manufactured, the pressure inside the drying room is more than 50 kPa. Therefore, in order to prevent cracks from forming, it is necessary to decrease the output of the microwave radiating device 131 and irradiate the both sides of the ceramic molded body in the longitudinal direction to dry the ceramic molded body for 24 hours.

According to the embodiment of the present invention, it is possible to provide a manufacturing method of a ceramic fired body of which cracks can be prevented from forming and which can be dried within a short time, a manufacturing method of a honeycomb structure using the manufacturing method of a ceramic fired body, and a manufacturing method of an exhaust gas converting device. Further, it is possible to provide a drying apparatus which can be used for the manufacturing method of the ceramic fired body.

Obviously, numerous modifications and variations of the present invention are possible in light of the above teachings. It is therefore to be understood that within the scope of the appended claims, the invention may be practiced otherwise than as specifically described herein.

What is claimed is:

1. A manufacturing method of a ceramic fired body, comprising:
forming a composition of ceramic raw material containing water to make a ceramic molded body;
irradiating the ceramic molded body with a microwave under a depressurized atmosphere of about 1 KPa or more and about 50 kPa or less to dry the ceramic molded body; and
firing the ceramic molded body to make the ceramic fired body.

2. The manufacturing method of the ceramic fired body according to claim 1,
wherein a drying apparatus is used for drying the ceramic molded body, and the drying apparatus includes a drying room for drying the ceramic molded body, a depressurizor for depressurizing an inside of the drying room, and a microwave irradiator for irradiating the ceramic molded body inside the drying room with the microwave.

3. The manufacturing method of the ceramic fired body according to claim 2,
wherein the drying apparatus is a continuous type.

4. The manufacturing method of the ceramic fired body according to claim 1,
wherein the ceramic molded body has plural through holes arranged in parallel in longitudinal directions of the plural through holes, and each of the plural through holes is separated from each other by a separating wall.

5. The manufacturing method of the ceramic fired body according to claim 4,
wherein the composition of ceramic raw material includes zeolite and an inorganic binder.

6. The manufacturing method of the ceramic fired body according to claim 5,
wherein the composition of ceramic raw material further includes at least one of an inorganic fiber, a flake-like material, a tetrapod-like material, and a three-dimensional needle-like material.

7. The manufacturing method of the ceramic fired body according to claim 5,
wherein the zeolite is phosphate zeolite.

8. The manufacturing method of the ceramic fired body according to claim 4,
wherein the ceramic molded body has a first end surface and a second end surface at each end of the ceramic molded body in a longitudinal direction of the ceramic molded body, and the first end surface and the second end surface of the ceramic molded body are irradiated with infrared rays while irradiating the ceramic molded body with the microwave.

9. The manufacturing method of the ceramic fired body according to claim 8,
wherein a lamp heater, a halogen heater, or a far infrared ray (FIR) heater is used for irradiating the first end surface and the second end surface of the ceramic molded body with the infrared rays.

10. The manufacturing method of the ceramic fired body according to claim 8,
wherein a drying apparatus is used for irradiating the ceramic molded body,
the drying apparatus includes a drying room for drying the ceramic molded body, a depressurizor for depressurizing an inside of the drying room, and a microwave irradiator for irradiating the ceramic molded body inside the drying room with the microwave, and
an infrared ray irradiator is used for irradiating the first end surface and the second end surface of the ceramic molded body with the infrared rays.

11. The manufacturing method of the ceramic fired body according to claim 10,
wherein the drying apparatus is a continuous type.

12. The manufacturing method of the ceramic fired body according to claim 5,
wherein the zeolite is β-type zeolite, Y-type zeolite, ferrierite, ZSM-5 zeolite, mordenite, faujasite, zeolite A, zeolite L, or phosphate zeolite.

13. The manufacturing method of the ceramic fired body according to claim 7,
wherein the phosphate zeolite is SAPO, MeAPO, or MeAPSO.

14. The manufacturing method of the ceramic fired body according to claim 13,
wherein the phosphate zeolite is SAPO-5, SAPO-11, or SAPO-34.

15. The manufacturing method of the ceramic fired body according to claim 5,
wherein ions in the zeolite are exchanged by copper ions, iron ions or both of copper ions and iron ions.

16. The manufacturing method of the ceramic fired body according to claim 5,
wherein average particle diameters of primary particles or secondary particles of the zeolite is from about 0.5 to about 10 μm.

17. The manufacturing method of the ceramic fired body according to claim 2,
wherein the drying apparatus further includes a repressurizing room, and
the depressurizor, the drying room, and the repressurizing room are sequentially arranged in a direction of carrying the ceramic molded body.

18. The manufacturing method of the ceramic fired body according to claim 2,
wherein the ceramic molded body is carried by a conveyer while being fixed to a jig.

19. The manufacturing method of the ceramic fired body according to claim 2,
wherein the ceramic molded body has a first end surface and a second end surface at each end of the ceramic molded body in a longitudinal direction of the ceramic molded body, and the drying apparatus further includes an infrared ray irradiator for irradiating the first end surface and the second end surface of the ceramic molded body with infrared rays.

20. A manufacturing method of a honeycomb structure including a ceramic fired body comprising:
a manufacturing method of the ceramic fired body comprising:
forming a composition of ceramic raw material containing water to make a ceramic molded body;
irradiating the ceramic molded body with a microwave under a depressurized atmosphere of about 1 KPa or more and about 50 kPa or less to dry the ceramic molded body; and
firing the ceramic molded body to make the ceramic fired body,
wherein the ceramic molded body has plural through holes arranged in parallel in longitudinal directions of the plural through holes, and each of the plural through holes is separated from each other by a separating wall.

21. The manufacturing method of the honeycomb structure according to claim 20,
wherein the composition of ceramic raw material includes zeolite and an inorganic binder.

22. The manufacturing method of the honeycomb structure according to claim 21,
wherein the composition of ceramic raw material further includes at least one of an inorganic fiber, a flake-like material, a tetrapod-like material, and a three-dimensional needle-like material.

23. The manufacturing method of the honeycomb structure according to claim 21,
wherein the zeolite is phosphate zeolite.

24. The manufacturing method of the honeycomb structure according to claim 20,
wherein the ceramic molded body has a first end surface and a second end surface at each end of the ceramic molded body in a longitudinal direction of the ceramic molded body, and the first end surface and the second end surface of the ceramic molded body are irradiated with infrared rays while irradiating the ceramic molded body with the microwave.

25. The manufacturing method of the honeycomb structure according to claim 24,
wherein a lamp heater, a halogen heater, or a far infrared ray (FIR) heater is used for irradiating the first end surface and the second end surface of the ceramic molded body with the infrared rays.

26. The manufacturing method of the honeycomb structure according to claim 24,
wherein a drying apparatus is used for irradiating the ceramic molded body,
the drying apparatus includes a drying room for drying the ceramic molded body, a depressurizor for depressurizing an inside of the drying room, and a microwave irradiator for irradiating the ceramic molded body inside the drying room with the microwave, and
an infrared ray irradiator for irradiating the first end surface and the second end surface of the ceramic molded with the infrared rays.

27. The manufacturing method of the honeycomb structure according to claim 26,
wherein the drying apparatus is a continuous type.

28. The manufacturing method of the honeycomb structure according to claim 21,
wherein the zeolite is β-type zeolite, Y-type zeolite, ferrierite, ZSM-5 zeolite, mordenite, faujasite, zeolite A, zeolite L, or phosphate zeolite.

29. The manufacturing method of the honeycomb structure according to claim 23,
wherein the phosphate zeolite is SAPO, MeAPO, or MeAPSO.

30. The manufacturing method of the honeycomb structure according to claim 29,
wherein the phosphate zeolite is SAPO-5, SAPO-11, or SAPO-34.

31. The manufacturing method of the honeycomb structure according to claim 21,
wherein ions in the zeolite are exchanged by copper ions, iron ions or both of copper ions and iron ions.

32. The manufacturing method of the honeycomb structure according to claim 21,
wherein average particle diameters of primary particles or secondary particles of the zeolite is from about 0.5 to about 10 μm.

33. The manufacturing method of the honeycomb structure according to claim 20,
wherein the ceramic molded body is carried by a conveyer while being fixed to a jig.

34. The manufacturing method of the honeycomb structure according to claim 20,
wherein a plurality of the ceramic fired bodies as honeycomb units are to be bonded to form a honeycomb structure.

35. The manufacturing method of the honeycomb structure according to claim 20,
wherein a number of the ceramic fired body to manufacture one honeycomb unit is one.

36. A manufacturing method of an exhaust gas converting device including a honeycomb structure comprising:
a manufacturing method of the honeycomb structure including a ceramic fired body comprising:
a manufacturing method of the ceramic fired body comprising:
forming a composition of ceramic raw material containing water to make a ceramic molded body;
irradiating the ceramic molded body with a microwave under a depressurized atmosphere of about 1 KPa or more and about 50 kPa or less to dry the ceramic molded body; and
firing the ceramic molded body to make the ceramic fired body,
wherein the ceramic molded body has plural through holes arranged in parallel in longitudinal directions of the plural through holes, and each of the plural through holes is separated from each other by a separating wall.

37. The manufacturing method of the exhaust gas converting device according to claim 36,
wherein the composition of ceramic raw material includes zeolite and an inorganic binder.

38. The manufacturing method of the exhaust gas converting device according to claim 37,
wherein the composition of ceramic raw material further includes at least one of an inorganic fiber, a flake-like material, a tetrapod-like material, and a three-dimensional needle-like material.

39. The manufacturing method of the exhaust gas converting device according to claim 37,
wherein the zeolite is phosphate zeolite.

40. The manufacturing method of the exhaust gas converting device according to claim 36,
wherein the ceramic molded body has a first end surface and a second end surface at each end of the ceramic molded body in a longitudinal direction of the ceramic molded body, and the first end surface and the second end surface of the ceramic molded body are irradiated with infrared rays while irradiating the ceramic molded body with the microwave.

41. The manufacturing method of the exhaust gas converting device according to claim 40,
wherein a lamp heater, a halogen heater, or a far infrared ray (FIR) heater is used for irradiating the first end surface and the second end surface of the ceramic molded body with the infrared rays.

42. The manufacturing method of the exhaust gas converting device according to claim 40,
wherein a drying apparatus is used for irradiating the ceramic molded body,
the drying apparatus includes a drying room for drying the ceramic molded body, a depressurizor for depressurizing an inside of the drying room, and a microwave irradiator for irradiating the ceramic molded body inside the drying room with the microwave, and
an infrared ray irradiator is used for irradiating the first end surface and the second end surface of the ceramic molded body with the infrared rays.

43. The manufacturing method of the exhaust gas converting device according to claim 42,
wherein the drying apparatus is a continuous type.

44. The manufacturing method of the exhaust gas converting device according to claim 37,
wherein the zeolite is β-type zeolite, Y-type zeolite, ferrierite, ZSM-5 zeolite, mordenite, faujasite, zeolite A, zeolite L, or phosphate zeolite.

45. The manufacturing method of the exhaust gas converting device according to claim 39,
wherein the phosphate zeolite is SAPO, MeAPO, or MeAPSO.

46. The manufacturing method of the exhaust gas converting device according to claim 45,
wherein the phosphate zeolite is SAPO-5, SAPO-11, or SAPO-34.

47. The manufacturing method of the exhaust gas converting device according to claim 37,
wherein ions in the zeolite are exchanged by copper ions, iron ions or both of copper ions and iron ions.

48. The manufacturing method of the exhaust gas converting device according to claim 37,
wherein average particle diameters of primary particles or secondary particles of the zeolite is from about 0.5 to about 10 μm.

49. The manufacturing method of the exhaust gas converting device according to claim 36,
wherein the ceramic molded body is carried by a conveyer while being fixed to a jig.

50. The manufacturing method of the exhaust gas converting device according to claim 36,
wherein a plurality of the ceramic fired bodies as honeycomb units are to be bonded to form a honeycomb structure.

51. The manufacturing method of the exhaust gas converting device according to claim 36,
wherein a number of the ceramic fired body to manufacture one honeycomb unit is one.

52. The manufacturing method of the exhaust gas converting device according to claim 36, further comprising:
arranging a holding sealing material on an outer periphery of the honeycomb structure; and
canning the honeycomb structure having the holding sealing material into a metallic pipe.

53. A drying apparatus that dries a ceramic molded body having plural through holes arranged in parallel in longitudinal directions of the through holes, and having a first end surface and a second end surface at each end of the ceramic molded body in a longitudinal direction of the ceramic molded body, each of the through holes being separated from each other by a separating wall, the drying apparatus comprising:
a drying room configured to dry the ceramic molded body;
a depressurizor configured to depressurize an inside of the drying room;
a microwave irradiator configured to irradiate the ceramic molded body inside the drying room with a microwave; and
an infrared ray irradiator configured to irradiate both end surfaces of the ceramic molded body in its longitudinal direction with infrared rays.

54. The drying apparatus according to claim 53,
wherein the infrared ray irradiator is a lamp heater, a halogen heater, or a far infrared ray (FIR) heater.

55. The drying apparatus according to claim 53,
wherein the drying apparatus is a continuous type.

56. The drying apparatus according to claim 53, further comprising:
a repressurizing room,
wherein the depressurizor, the drying room, and the repressurizing room are sequentially arranged in a direction of carrying the ceramic molded body.

57. The drying apparatus according to claim 53, further comprising:
a conveyer configured to carry a jig,
wherein the ceramic molded body is carried by the conveyer while being fixed to the jig.
